(19) United States
(12) Patent Application Publication
(10) Pub. No.: US 2010/0233790 A1
(43) Pub. Date: Sep. 16, 2010

(54) METHOD FOR BIOLOGICAL TREATMENT OF AN AIR STREAM CONTAINING VOCS

(75) Inventors: James T. BOSWELL, Montgomery, TX (US); Paul C. JOHN, Beaverton, OR (US); Karl W. Mundorff, Portland, OR (US)

Correspondence Address: CHERNOFF, VILHAUER, MCCLUNG & STENZEL, LLP, 601 SW Second Avenue, Suite 1600, PORTLAND, OR, 97204-3157, US

(73) Assignee: Bio-Reaction Industries, LLC, Tualatin, OR (US)

(21) Appl. No.: 12/722,448

(22) Filed: Mar. 11, 2010

Related U.S. Application Data
(60) Provisional application No. 61/160,219, filed on Mar. 13, 2009.

(51) Int. Cl. B01D 53/84

(52) U.S. Cl. 435/266

(57) ABSTRACT

A method of operating a facility that produces an emission air stream containing gas phase organic compounds includes providing a bio-oxidation system including a solid, biologically active filter material containing a population of thermophilic microbes. The emission air stream is supplied to the bio-oxidation system at a temperature of at least about 50° C., whereby the emission air stream passes through the bio-oxidation system in contact with the biologically active filter material. Conditions conducive to sustaining the population of thermophilic microbes in the biologically active filter material are maintained in the bio-oxidation system.

### CROSS-REFERENCE TO RELATED APPLICATION

This application claims benefit of U.S. Provisional Application No. 61/160,219 filed Mar. 13, 2009, the entire disclosure of which is hereby incorporated herein by reference for all purposes.

### BACKGROUND OF THE INVENTION

The subject matter of this application relates to a method for biological treatment of an air stream containing volatile organic compounds (VOCs).

U.S. Pat. No. 6,479,276 discloses a biological filter apparatus that comprises a biotrickling filter and a biofilter. The biotrickling filter contains a filter bed composed of a crossflow filter medium made of corrugated sheets of biologically inert synthetic polymer material bonded together in face to face relationship with the channels of alternate sheets inclined to each other at about 60°. The sheets are generally vertically oriented so that the channels pass upwards within the filter bed and are inclined at about 30° to vertical.

The biofilter contains a filter bed that includes a biologically active filter medium composed of compost-filled, polypropylene balls, as described in U.S. Pat. No. 6,524,849 issued Feb. 25, 2003.

In operation of the filter apparatus, water is sprayed onto the biotrickling filter from above and drains into a sump situated below the biotrickling filter. Water is also sprayed from above onto the biofilter and drains onto a catch surface that is located below the biofilter and is in communication with the sump. The water that drains onto the catch tray flows into the sump. The compost in the compost balls contains microbes (bacteria and fungi). The water that is sprayed onto the biofilter gradually erodes compost from the compost-filled balls and carries the eroded compost and bacteria and fungal cells onto the catch surface and from there into the sump. The water that accumulates in the sump is recycled by spraying onto the biotrickling filter and the biofilter. In this manner, the biotrickling filter is inoculated with microbes which form a biofilm on the biologically inert sheets of filter medium.

An emission air stream from an industrial process, such as a process in the wood products industry, enters the filter apparatus between the free surface of the water in the sump and the biotrickling filter and passes upward through the biotrickling filter, then over to the biofilter chamber and then downward through the biofilter, and is discharged to atmosphere. The microbes in the filter apparatus, sustained by nutrients added to the recirculating water, biologically degrade some of the gas phase organic compounds present in the emission air stream and the microbes' digestion of these materials produce small amounts (respiratory levels) of carbon dioxide.

Different parts of the filter apparatus are optimized for biological degradation of different types of organic compounds. Because of the microbes present in the sump waters, the sump waters act much like an extended aeration waste water treatment system. Some water soluble compounds present in the air stream entering the filter apparatus dissolve in the sump water and are consumed by the microbes present in the water, being converted to carbon dioxide and water.

As the effluent air stream passes upward through the biotrickling filter, water soluble vapor phase compounds that were not removed from the air stream by contact with the sump water spray contact the biofilm in the biotrickling filter and are biologically degraded by the microbes forming the biofilm.

VOCs, HAPs and odoriferous compounds that remain in the air stream leave the biotrickling filter and come into contact with the microbes present in the compost in the biofilter. Since the conditions in the biofilter are different from those in the biotrickling filter, the biofilter favors removal of other compounds than those that are removed by the biotrickling filter. In particular, the biofilter is effective for removal of hydrophobic compounds.

Efficient operation of the biotrickling filter and the biofilter requires that the microbes be provided with suitable nutrients, including nitrogen, phosphorus and minerals, to support the metabolic action of the microbes in converting the vapor phase organic compounds to carbon dioxide and water. This may be accomplished by adding the nutrients to the sump water which is distributed to the biotrickling filter and the biofilter.

Bacteria and fungi that can be employed for biological degradation of VOCs, HAPs and odoriferous compounds may be classified by reference to the temperature range that favors their operation. Microbes that operate at a temperature range from about 10° to 50° C. are referred to as mesophilic microbes, or mesophiles; those that operate at a temperature above about 50° C. are referred to as thermophilic microbes or thermophiles, and thermophilic microbes that operate at a temperature above about 80° C. are referred to as hyperthermophilic microbes or hyperthermophiles. In general, mesophiles can tolerate a fairly wide temperature range whereas different species of thermophiles are adapted to narrower temperature ranges.

Hitherto, practical implementations of the biological filter apparatus described in U.S. Pat. No. 6,479,276 have operated at temperatures below 50° C. Operation at relatively low temperatures may be advantageous because the apparatus can be manufactured using relatively inexpensive materials, such as piping made of standard, that is unchlorinated, PVC, whereas a biological filter apparatus that operates at temperatures significantly higher than 50° C. may require use of more expensive materials that can withstand the higher temperatures. However, industrial gasses requiring treatment to remove VOCs, HAPs and odoriferous gasses are often discharged at temperatures well above 50° C., and even as high as 85° C. Consequently, the gas stream must be cooled in order to be processed in the biological filter apparatus operated in the mesophilic temperature range, and if the gas stream is saturated with moisture, so that it cannot be cooled by humidification, this may necessitate dilution of the emission stream with ambient air. The ambient air dilution results in the gas stream to be processed having a much greater volume per unit time than the gas stream that is discharged from the industrial process, and in order to handle the higher gas volume the biological filter apparatus must be much larger than if no dilution were required. The capital cost of the system then may be much more than for other types of emission control technologies, rendering biofiltration unattractive.

Vegetative compost may contain mesophiles and several species of thermophiles. Depending on temperature, some species may be active and other species may be inactive and in a spore state. Specifically, in the case of a practical implementation of the biological filter apparatus described in U.S. Pat. No. 6,479,276 operating at a temperature below 50° C., species of mesophiles are active whereas species of thermophiles may be inactive. Nevertheless, as suggested above, the thermophiles are present in the compost. In the mesophilic temperature range, the mesophiles will out compete the thermophiles, keeping their populations to a minimum and/or, because of the relatively low operating temperature, thermophiles remain in a spore state. Consequently, although the thermophiles may be present at mesophilic temperatures, the quantities of thermophiles are much lower than the quantities of mesophiles.

In principal, it would be desirable to operate a biological filter apparatus in a thermophilic temperature range, but hitherto difficulties have been encountered in establishing and maintaining an adequate population of thermophiles to employ thermophiles in treatment of high temperature, highly saturated emission streams.

If a gas stream at a temperature significantly above 50° C. were supplied to a biological filter apparatus in which the active species were mesophilic, the mesophiles may be destroyed or forced into an inactive state.

At a wood products facility in Central Europe, there is in operation a bioscrubber system in which water laden with microbes is sprayed into a gas stream to wash pollutant particles from the gas. The droplets of water capture the soluble organics and particles and fall into a sump from which the water is re-circulated back to the spray nozzles. The microbes in the water biodegrade the water-soluble organics and particles that are captured by the spray droplets. The operating temperature of the biofilter system is higher than the maximum temperature that can be tolerated by mesophilic microbes, and accordingly the microbes that are present in the system are thermophilic. However, sustained operation at thermophilic temperatures has only occurred for short durations (approximately 30 days each cycle), after which the thermophilic microbes die out and the system must be re-inoculated with a new thermophilic culture. Appropriate removal efficiency of the targeted organics, methanol and formaldehyde, has not been able to be maintained over the long term.

### SUMMARY OF THE INVENTION

In accordance with the subject matter of this application there is provided a method of operating a facility that produces an emission air stream containing gas phase organic compounds, the method comprising providing a bio-oxidation system including a solid, biologically active filter material containing a population of thermophilic microbes, supplying the emission air stream to the bio-oxidation system at a temperature of at least about 50° C., whereby the emission air stream passes through the bio-oxidation system in contact with the biologically active filter material, and maintaining conditions in the bio-oxidation system conducive to sustaining the population of thermophilic microbes in the biologically active filter material.

Different species of thermophiles function in different temperature bands between about 50 and 85° C. At any given temperature in this range, several different species of thermophiles may be active, each species being active over a band of perhaps 10 to 15° C., often with considerable overlap. Thus, a method in accordance with the subject matter of this application is tolerant of quite wide variations in temperature of the emission air stream.

### BRIEF DESCRIPTION OF THE DRAWINGS

For a better understanding of the invention, and to show how the same may be carried into effect, reference will now be made, by way of example, to the accompanying drawings, in which:

FIG. 1 is a schematic diagram of an industrial facility including a source of gas phase organic compounds,

FIG. 2 is a schematic view of a biological filter apparatus included in the industrial facility shown in FIG. 1.

### DETAILED DESCRIPTION

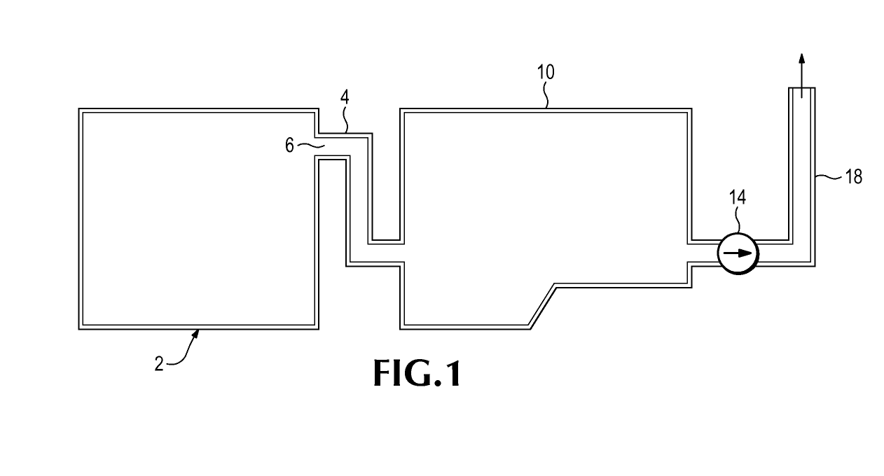

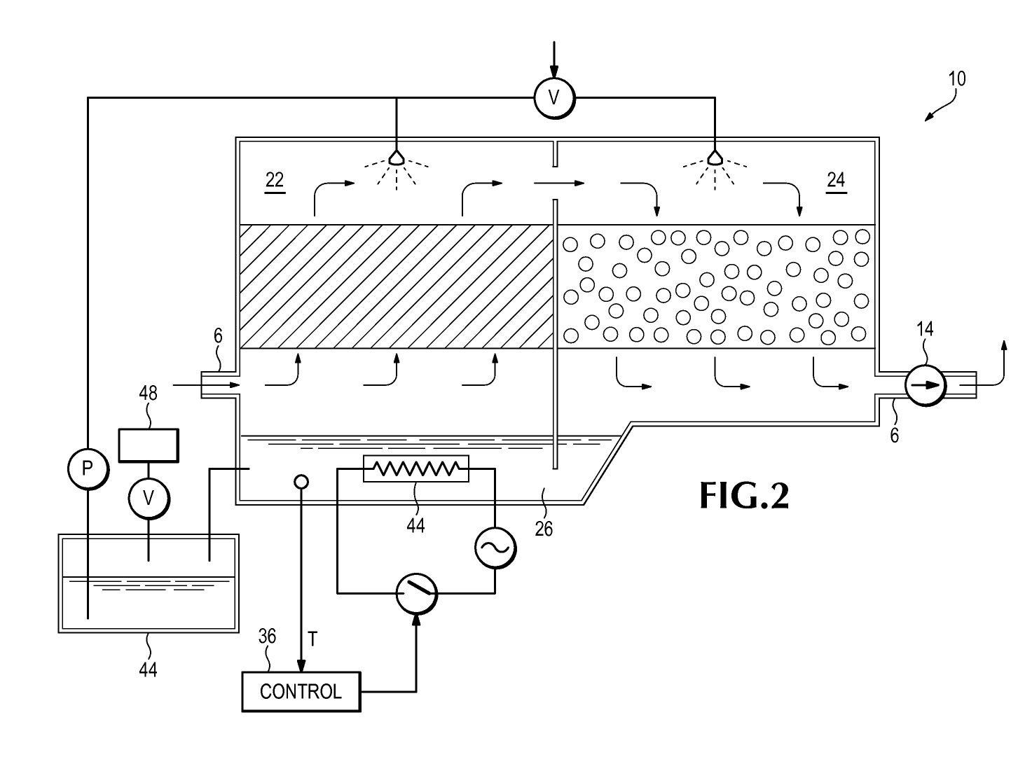

The industrial facility shown in FIG. 1 of the drawings may be, for example, a wood products plant, a bakery, or plant for preparation of human or animal food products. The facility includes a source 2 of gas phase organic compounds, such as VOCs, HAPs, and odoriferous gases. The source 2 may be a material drier. The industrial facility includes ducting 4 that connects an air outlet 6 of the source 2 to a biological filter apparatus 10, also shown in FIG. 2, a fan 14 that induces a flow of air from the outlet 6 with gas phase organic compounds entrained therein, and a stack 18 for discharge of the air into the ambient atmosphere. The flow of air constitutes an emission air stream of the industrial facility. The emission air stream passing through the outlet 6 is at a temperature in the range from about 50° C. to 80° C.

Referring to FIG. 2, the biological filter apparatus 10 comprises a biotrickling filter 22 and a biofilter 24. The biotrickling filter 22 contains a filter bed composed of a crossflow filter medium made of corrugated sheets of biologically inert synthetic polymer material bonded together in face to face relationship with the channels of alternate sheets inclined to each other at about 60°. The sheets are generally vertically oriented so that the channels pass upwards within the filter bed and are inclined at about 30° to vertical.

The biofilter 24 contains a filter bed that includes a biologically active filter medium composed of compost balls. The compost balls are loaded with compost from a source that contains both mesophiles and thermophiles.

In operation of the filter apparatus, water is sprayed continuously onto the biotrickling filter from above and drains into a sump situated below the biotrickling filter. Water is also sprayed intermittently from above onto the biofilter and drains onto a catch surface that is located below the biofilter and is in communication with the sump. The water that is sprayed onto the biofilter slowly erodes compost from the compost-filled balls and carries the eroded compost and bacterial and fungal growths onto the catch surface and from there into the sump. The compost and microbes suspended in the water that accumulates in the sump renders the water biologically active. The water in the sump is recycled by spraying onto the biotrickling filter and the biofilter. In this manner, the biotrickling filter is inoculated with microbes from the compost in the biofilter. The microbes form a biofilm on the biologically inert sheets of filter medium, and on the surface of the compost-filled balls in the biofilter.

At a functional level, a biological filter apparatus implementing the subject matter disclosed in this application is similar to a conventional implementation of the apparatus disclosed in U.S. Pat. No. 6,479,276. However, the apparatus is designed to withstand higher temperatures, which may necessitate use of piping made from stainless steel or CPVC, instead of PVC. Moreover, the temperature of the filter bed in the biofilter 24 is substantially higher (in the range from 52 to 85° C.) than in the case of the conventional implementation. In addition, the thermophilic microbes present in the compost are augmented by providing an additional inoculum of thermophilic microbes in order to form additional thermophilic biofilm in the system. The additional inoculum is prepared by brewing a compost tea of hot water (at the appropriate temperature of the future thermophilic operation in the biofiltration system) and compost from a vegetative composting operation where temperatures in the compost greatly exceed 50° C. and accordingly the conditions favor thermophilic microbes. The compost is allowed to steep in the hot water for 12 to 24 hours. A quantity of the supernatant liquid, in proportion to the sump volume, is added to the existing sump water in the system, e.g. from a tank 48. The tea may be brewed in the tank 48 or it may be brewed separately and decanted into the tank 48.

In order to achieve successful thermophilic operation of the biofiltration system, it has been found desirable to operate the system for from two to three weeks at thermophilic temperatures, with twice weekly inoculation with the thermophilic tea as described above.

Further, against the possibility of a long shut-down occurring, such as to interrupt the hot emission air stream, a supplemental brooder tank of organisms (maintained at the thermophilic operating temperature) may be provided to re-inoculate the biofilter system several hours, e.g. 12 hours, prior to its restart. This brooder tank of thermophiles will ensure rapid reestablishment of a thermophilic system. The tank 48 may serve as the brooder tank.

The emission air stream passes from the source 2 to the biological filter apparatus without substantial dilution with ambient air, and accordingly the air stream entering the biological filter apparatus is at a temperature above about 50° C. This temperature may not be tolerated by mesophiles present in the filter apparatus, which accordingly may be destroyed or forced into a spore state, but may favor thermophiles. In the event that the emission stream leaving the plant 2 is particularly hot, e.g. at a temperature exceeding 77° C., it may be necessary to cool the emission stream before entering the biofilter. Frequently, this may be accomplished by humidification in the biotrickling filter. Most of the industrial processes operating at these high temperatures are already saturated and since no one had been able to operate a biological system successfully for this type of application, then no one had.

The sump water serves not only as an extended aeration waste water treatment system but also to humidify the emission stream and moderate temperature variations.

The thermophiles present in the biological filter apparatus metabolically convert VOCs and other organic vapor phase compounds in the emission air stream to carbon dioxide and water. Suitable nutrients, such as compounds containing nitrogen, phosphorus and minerals, are added to the recirculating water in order to support the metabolic action of the thermophiles. Because of the favorable temperature and nutrient conditions, the thermophiles oxidize gas phase organic compounds present in the emission air stream, converting them to carbon dioxide and water. Surprisingly, it has been found that the thermophiles convert the gas phase organic compounds to carbon dioxide and water at a higher metabolic rate than mesophiles, allowing treatment of an equivalent emission air stream in a substantially smaller biofiltration system than if mesophiles were employed.

The compost may contain numerous species of thermophiles, such that at any given temperature five to eight or more species may be active, each species being active over a range of perhaps 10 to 15° C., often with considerable overlap. Thus, in the event that the temperature of the emission air stream changes, the active species of thermophiles may also change. The biological filter apparatus is therefore tolerant of change in temperature of the emission air stream.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method of operating a facility that produces an emission air stream containing gas phase organic compounds, the method comprising:
providing a bio-oxidation system including a solid, biologically active filter material containing a population of thermophilic microbes,
supplying the emission air stream to the bio-oxidation system at a temperature of at least about 50° C., whereby the emission air stream passes through the bio-oxidation system in contact with the biologically active filter material, and
maintaining conditions in the bio-oxidation system conducive to sustaining the population of thermophilic microbes in the biologically active filter material.

2. A method according to claim 1, comprising supplying the emission air stream from said facility substantially without dilution with ambient air.

3. A method according to claim 1, wherein the bio-oxidation system includes a biotrickling filter containing an inert filter medium and also includes a biofilter containing said biologically active filter material, and the method comprises spraying water onto the biologically active filter material, collecting water that drains from the biologically active filter material, and recirculating the collected water by spraying onto the inert filter medium and onto the biologically active filter material, whereby the recirculating water is inoculated with thermophilic microbes from the biologically active filter material and a population of thermophilic microbes is established in the biotrickling filter.

4. A method according to claim 3, further comprising periodically augmenting the population of thermophilic microbes in the recirculating water by adding an aqueous infusion containing thermophilic microbes to the recirculating water.
